(19) United States
(12) Patent Application Publication
(10) Pub. No.: US 2016/0250761 A1
(43) Pub. Date: Sep. 1, 2016

(54) Razor

(71) Applicants: Carl Frank Zoller, Troy, MI (US); Ryan Davis, Commerce Township, MI (US)

(72) Inventors: Carl Frank Zoller, Troy, MI (US); Ryan Davis, Commerce Township, MI (US)

(21) Appl. No.: 15/048,912

(22) Filed: Feb. 19, 2016

Related U.S. Application Data
(60) Provisional application No. 62/117,997, filed on Feb. 19, 2015.

(51) Int. Cl. B26B 21/40; B26B 21/18

(52) U.S. Cl. CPC B26B 21/4012; B26B 21/18

(57) ABSTRACT

A two-sided razor for shaving includes a first shaving side for shaving shorter and/or finer hair and a second shaving side for shaving longer and/or coarser hair. The razor includes a gap on the second shaving side approximately between fifty percent (50%) and one hundred fifty percent (150%) larger than a gap on the first shaving side. The razor includes a double-edged razor blade between a top portion and a bottom portion including a first chute aligned with the first shaving side and a second chute aligned with the second shaving side and wherein the second chute is sized approximately between fifty percent (50%) and one hundred fifty percent (150%) larger than the first chute on the first shaving side of the razor.

### CROSS-REFERENCE TO RELATED APPLICATIONS

This application claims priority to U.S. provisional patent application No. 62/117,997, filed Feb. 19, 2015, to Zoller and titled: Course and Fine Cut Shaver, the contents of which are incorporated herein by reference for all purposes.

### FIELD

The present disclosure generally relates to a razor for removing or shaving hair from an animal, such as a person. More particularly, the present disclosure relates to razor for removing or shaving facial hair from a person.

### BACKGROUND

Various razors and improvements to razors have been suggested in the past. Many types of safety razors are known such as those disclosed in U.S. Pat. Nos. 1,486,418, 2,034,262, 2,041,778, 2,055,837, 2,270,388, 2,461,444, 2,588,033, 2,593,306, 2,795,847, 3,675,323, 4,184,247, US Patent Application Publication Number 2011/0162208; and Chinese Patent Number CN 1103664C. Despite many failed attempts in the prior art, what is still needed today is a razor for shaving facial hair providing better control and comfort as well as greater flexibility and utility of use.

### BRIEF DESCRIPTION OF THE DRAWINGS

FIG. 1 illustrates a perspective view of a razor according to an embodiment of the present disclosure;

FIG. 2 illustrates an alternate perspective view of the razor of F;

FIG. 3 illustrates an alternate perspective view of head of the razor of FIGS. 1 and 2;

FIG. 4 is a top view of the razor of FIG. 1;

FIG. 5 is a bottom view of the razor of FIG. 1;

FIG. 6 is an exploded side view of the razor of FIG. 1;

FIG. 7 is a top view of the razor of FIG. 1 with the top removed;

FIG. 8 is a section side view of the razor of FIG. 1;

FIG. 9 is a section side view of a razor according to an embodiment of the present disclosure;

### DETAILED DESCRIPTION

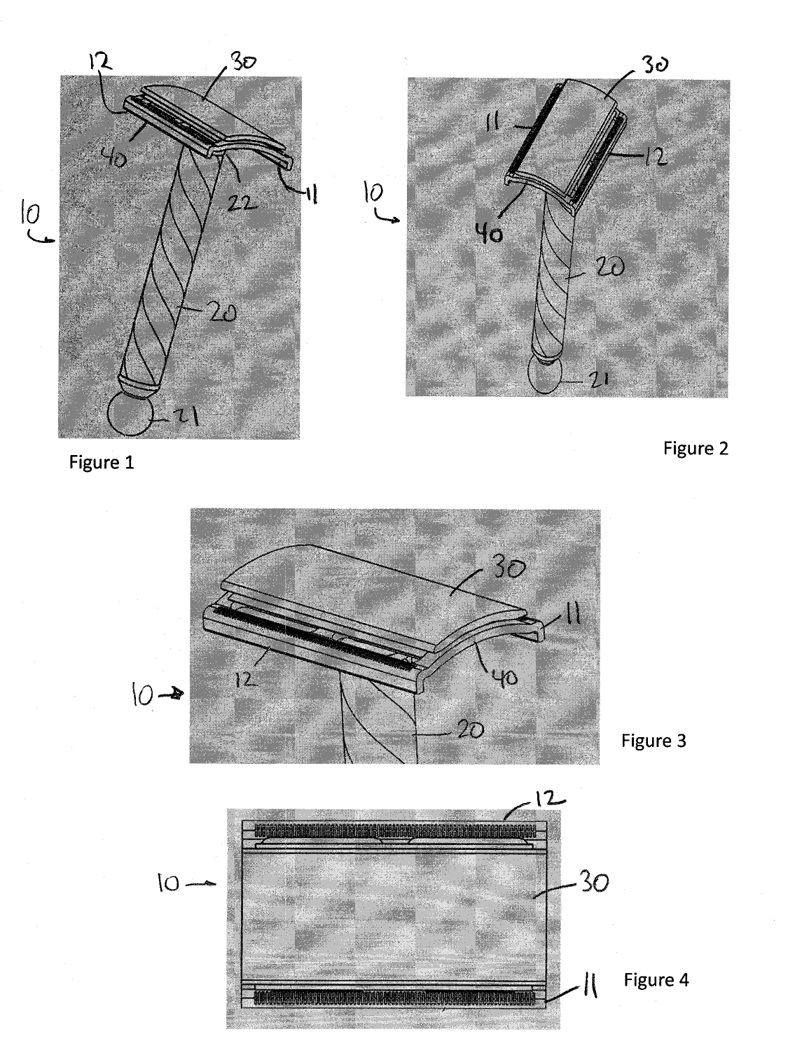

Referring generally to the figures and in particular to FIGS. 1 and 2, there is shown in alternate perspective views a razor 10 according to an embodiment of the present disclosure. The razor 10 may preferably include a first shaving side 11 and a second shaving side 12. As will become clear after reading the entire disclosure, the razor 10 of the present disclosure has particular utility in shaving both coarse and fine hair because the first and second shaving sides of 11 and 12, respectively, are designed having different size shaving gaps and different size chutes as described below. It should also be appreciated that while the present disclosure relates to a generally traditional type of shaving razor 10, alternative designs and applications will be readily understood.

The razor 10 may include a handle portion 20 having a first or lower end 21 and an upper or second end 22. The razor 10 may further include a top portion 30 coupled to the second end 22 of the handle portion 20. It will be appreciated that the handle portion 20 includes a design similar to a barbershop pole including a generally spherical lower end 21 but may be of any known or appropriate construction for use as a handle 20 on the razor 10.

The razor 10 may further include a bottom portion 40 coupled to the upper end 22 of the handle portion 20 in a generally understood manner. Referring now in particular to FIG. 6, an exploded end view of the razor 10 is shown. The upper end 22 of the handle portion 20 has a generally round and threaded cross-section hole 23 for receiving a threaded extension member 32 of the top portion 30. The bottom portion 40 may include an extension member 42 including a hole 43 for coupling the bottom portion 40 to the upper end 22 of the handle portion 20 such that the handle portion 20 may be turned relative to the top portion 30 so that the extension portion 32 of the top portion 30 passes through the centrally located hole 43 in the base portion 40 and into the end 22 of the handle portion 20 to couple a double-edged razor blade 50 in the razor 10.

Referring in particular to FIG. 7, there is a top view of the razor 10 with the top portion 30 removed. The double-edged razor 50 is shown in the base portion 40. The razor 50 may include a centrally located hole or passage 52 and may include notches 54 for receiving extension members 45 formed in the base 40 for fixedly, rotationally coupling the double-edged razor 50 and preventing its rotational movement with respect to the base portion 40.

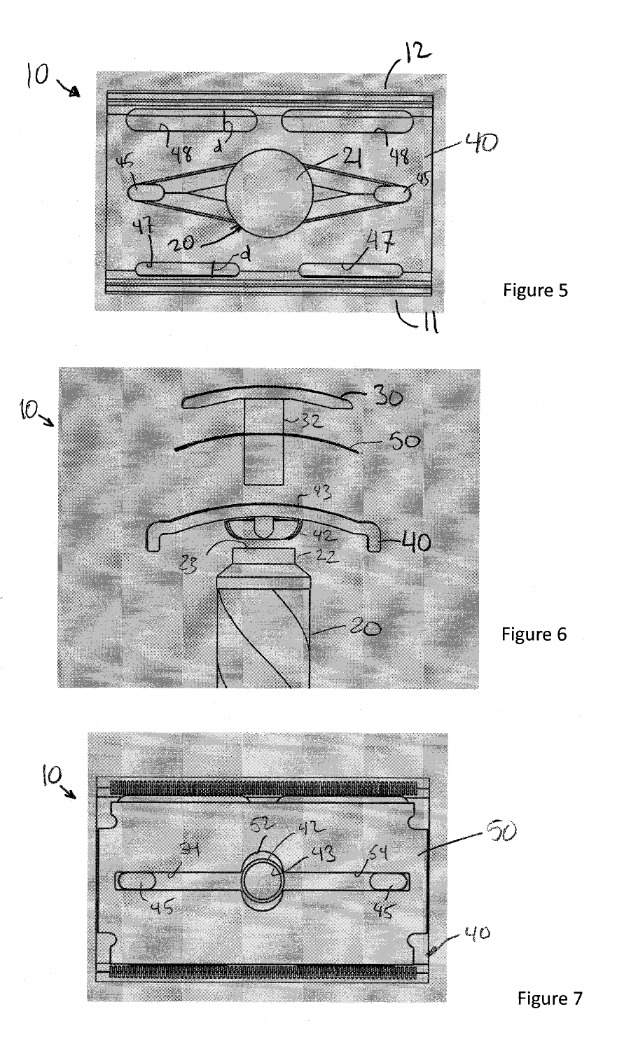

Referring in particular to FIG. 5, there is shown a bottom view of the razor 10 showing the detail of the bottom portion 40. In particular, the bottom portion 40 may include a first pair of discharge chutes 47 located proximal the first shaving side 11 of the razor 10. The discharge chutes 47 are holes passing through the bottom portion 40 and located proximal the first edge of the razor blade 50 for discharging whiskers and stubble removed by the razor blade 50. Similarly, the bottom portion 40 may include a second pair of discharge chutes 48 located proximal the second shaving side 12 of the razor 10. Generally, the shapes of the first and second discharge chutes 47 and 48, respectively, are oblong passages having generally to parallel sides spaced a predetermined distance (d) apart to define the sides of the respective chute 47 and 48. It should be noted that the distance d for the chutes 47 is less than the distance d for the chutes 48. In one embodiment of the present disclosure, the distance d for the chutes 48 may be preferably fifty percent (50%) larger than the distance d for the chutes 47. In a further embodiment of the present disclosure, the distance d for the chutes 48 may preferably be 75% larger than the distance d for the chutes 47. In a still further embodiment of the present disclosure, the distance d for the chutes 48 may preferably be 100% larger than the distance d for the chutes 47. In a still further embodiment of the present disclosure, the distance d for the chutes 48 may preferably be 125% larger than the distance d for the chutes 47. In a still further embodiment of the present disclosure, the distance d for the chutes 48 may preferably be 150% larger than the distance d for the chutes 47. The larger chutes 48 on the second shaving side 12 of the razor 10 may better accommodate longer whiskers and stubble removed by the edge of the razor blade 50 as compared to the relatively smaller chutes 47 of the first shaving side 11 of the razor 10.

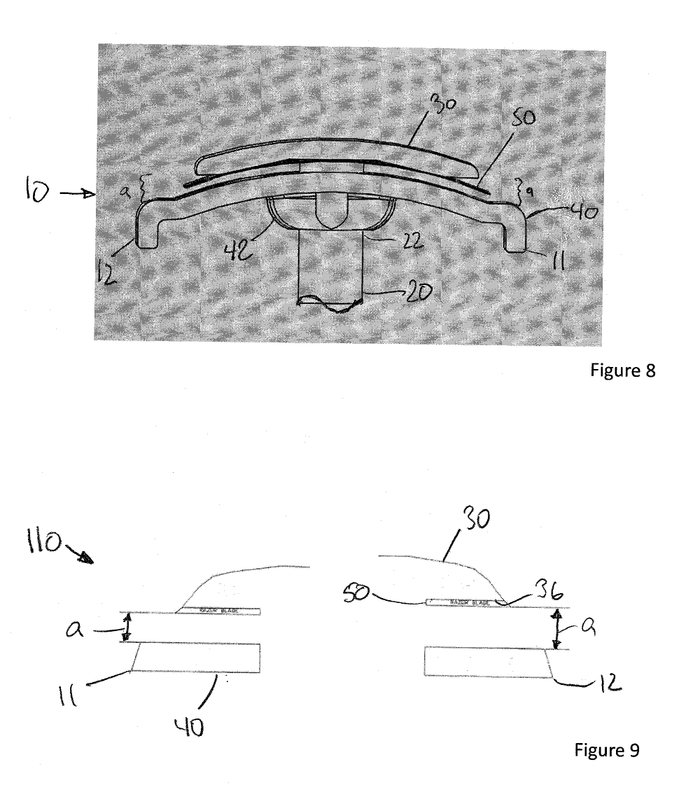

Referring now to FIG. 8, a side or end view of the razor 10 is shown including the top portion 30, the base portion 40, and the installed razor blade 50 are all coupled to the handle portion 20 after the handle portion 20 is adjusted. The first and second edges of the blade 50 extend beyond the first and second edges of the top portion 30 and short of the first and second edges of the base portion 40 to define an “a” gap on each of the first and second sides 11 and 12, respectively, of the razor 10. A user may now select between using the first side 11 of the razor 10 aligned with the chutes 47 for shaving shorter and finer hair and the second side 12 aligned with the chutes 48 for more comfortably shaving longer and coarser hair.

Referring now to FIG. 9, a razor 110 according to an embodiment of the present disclosure is shown in cross section side view. Similar to the razor 10, the razor 110 includes a first shaving side 11 and a second shaving side 12. Generally, the razor 110 may include a top or cover portion 30 similar to that of the embodiment of FIG. 1 but may have a lower surface 36 offset on the second side 12 from the lower surface 36 on the first side 36 to define a gap a on the first side 11 different from a gap a on the second side 12. In general, the gap a on the second side 12, may preferably be larger than the gap a on the first side of 11. In one embodiment, the gap a on the second side 12, may preferably be approximately 50% larger than the gap a on the first side 11. In a further embodiment, the gap a on the second side 12, may preferably be approximately 75% larger than the gap a on the first side 11. In still a further embodiment, the gap a on the second side 12, may preferably be approximately 100% larger than the gap a on the first side 11. In still a further embodiment, the gap a on the second side 12, may preferably be approximately 125% larger than the gap a on the first side 11. In one embodiment of the present disclosure, the gap a on the second side 12, may preferably be approximately 2.26 mm and the gap a on the first side may preferably be approximately 1.13 mm.

It should be understood according to the present disclosure that it is possible to combine the features of the differing size gaps “a” on the first and second sides 11 and 12 of the razor 110 (as shown in FIGS. 8 and 9) with the features of the differing size distances “d” of the first and second chutes 47 and 48, respectively, of the first and second sides 11 and 12 of the bottom portion 40 of the razor 10 as shown in FIGS. 1-8. It is believed that such a razor 10 may have particular utility and comfort benefits for an individual user having both finer and shorter hair to be shaved as well as coarser and longer haired to be shaved.

While embodiments of the present invention have been illustrated and described, it is not intended that these embodiments illustrate and describe every conceivable form of the present invention. Rather the words used in the specification are words of description rather than limitation, and it is understood that various changes may be made without departing from the spirit and scope of the present invention.

We claim:

1. A razor for shaving, the razor including a first shaving side and a second shaving side located distal from the first shaving side, the razor comprising:
a. a handle portion having a top end and a bottom end;
b. a base portion coupled proximal the top end of the handle portion;
c. a top portion for coupling with the handle portion;
d. a double-edged razor blade including a centrally located passage for coupling the razor blade to the base portion; and
e. wherein the base includes a first discharge chute located proximal a first edge and aligned with the first shaving side of the razor and a second discharge chute located proximal a second edge and aligned with the second shaving side of the razor and the wherein the first and second discharge chutes have different sizes for discharging the shaved hair.

2. The razor of claim 1 wherein the first and second chutes are for discharging fine and coarse hair, respectively.

3. The razor of claim 2 wherein the second discharge chute is approximate fifty percent (50%) larger than the first discharge chute.

4. The razor of claim 2 wherein the second discharge chute is approximate seventy-five percent (75%) larger than the first discharge chute.

5. The razor of claim 2 wherein the second discharge chute is approximate one hundred percent (100%) larger than the first discharge chute.

6. The razor of claim 2 wherein the second discharge chute is approximate one hundred fifty percent (150%) larger than the first discharge chute.

7. A razor for shaving, the razor including a first shaving side and a second shaving side located distal from the first shaving side, the razor comprising:
a. a handle portion having a top end and a bottom end;
b. a base portion coupled proximal the top end of the handle portion;
c. a top portion for coupling with the handle portion;
d. a double-edged razor blade including a centrally located passage for coupling the razor blade to the base portion and wherein the top portion couples the razor blade to the base portion and include a first gap defined by the distance between a bottom of the razor blade and the razor base aligned with the first shaving side of the razor and a second gap defined by the distance between a bottom of the razor blade and the razor base aligned with the second shaving side of the razor; and
e. wherein the base portion includes a first discharge chute located proximal the first shaving side of the razor and a second discharge chute located proximal the second shaving side of the razor and the wherein the first and second discharge chutes have different sizes.

8. The razor of claim 7 wherein the first and second chutes are for discharging stubble.

9. The razor of claim 7 wherein the second discharge chute is approximate fifty percent (50%) larger than the first discharge chute.
